(19) United States
(12) Patent Application Publication
(10) Pub. No.: US 2026/0148094 A1
(43) Pub. Date: May 28, 2026

(54) MULTIPLE PERSPECTIVE CROSS-SITE SCRIPTING DETECTION

(71) Applicant: Palo Alto Networks, Inc., Santa Clara, CA (US)

(72) Inventors: Haozhe Zhang, San Jose, CA (US); Zhibin Zhang, Santa Clara, CA (US); Qi Deng, Sunnyvale, CA (US); Shengming Xu, San Jose, CA (US)

(21) Appl. No.: 18/960,552

(22) Filed: Nov. 26, 2024

Related U.S. Application Data
(60) Provisional application No. 63/724,141, filed on Nov. 22, 2024.

(51) Int. Cl. G06N 5/01; G06N 5/02

(52) U.S. Cl. CPC G06N 5/01; G06N 5/02

(57) ABSTRACT

An artificial intelligence ensemble has been developed for XSS detection with high accuracy. The artificial intelligence ensemble is created with a deep learning model and a machine learning model, each trained on different perspectives of token sequences extracted from packet payloads. Pre-processing of the raw data (i.e., the packet payload) generates a sequence of tokens that represents the payload and then generates a sequence of abstract tokens from the sequence of tokens. The deep learning model is trained on abstract token sequences to detect XSS from the perspective of patterns of token sequences. The other model is trained on pattern-based features extracted from the sequence of tokens to detect XSS from the perspective of features corresponding to characteristics of tokens sequences corresponding to heuristics gleaned for XSS. After each model is trained, the models are combined and deployed for inline detection of XSS in payload traffic from the different perspectives.

### BACKGROUND

The disclosure generally relates to machine-learning based cross-site scripting detection (e.g., CPC subclass G06N and/or H04L 63).

OWASP (Open Web Application Security Project) describes Cross-Site Scripting (XSS) attacks injection type attacks that inject malicious code into websites that are typically trusted or benign. Typically, a malicious actor will use a web application to send malicious code (e.g., a browser side script) to a different end user via a trusted/benign website. The victim end user's browser will execute the script since the browser receives the script from the trusted/benign website. The malicious script can access any cookies, session tokens, or other sensitive information retained by the browser and used with that website. XSS has been classified as Reflected XSS, Stored XSS, or DOM-based XSS. But XSS often falls within multiple of these categories, so researchers generally categorized XSS as Server XSS or client XSS.

Despite XSS attacks being present for many years, detection is still challenging, at least because minor variations in XSS evade signature-based detection. XSS attacks can be used to incur financial losses, compromise sensitive data, distribute malware deface websites, launch phishing campaigns, etc.

### BRIEF DESCRIPTION OF THE DRAWINGS

Embodiments of the disclosure may be better understood by referencing the accompanying drawings.

FIG. 1 is a diagram of a multi-perspective XSS detector deployed for inline detection of XSS.

FIG. 2 is a flowchart of example operations for detecting XSS with a multi-perspective machine learning ensemble.

FIG. 3 is a flowchart of example operations for training models to detect XSS based on multiple perspectives of a payload.

FIG. 4 depicts an example computer system with a multi-perspective XSS detector powered by a machine-learning ensemble.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

An artificial intelligence ensemble has been developed for XSS detection with high accuracy. The artificial intelligence ensemble is created with a deep learning model and a machine learning model, each trained on different perspectives of token sequences extracted from packet payloads. Pre-processing of the raw data (i.e., the packet payload) generates a sequence of tokens that represents the payload and then generates a sequence of abstract tokens from the sequence of tokens. The deep learning model is trained on abstract token sequences to detect XSS from the perspective of patterns of token sequences. The other model is trained on pattern-based features extracted from the sequence of tokens to detect XSS from the perspective of features corresponding to characteristics of tokens sequences corresponding to heuristics gleaned for XSS. After each model is trained, the models are combined and deployed for inline detection of XSS in payload traffic from the different perspectives.

### Example Illustrations

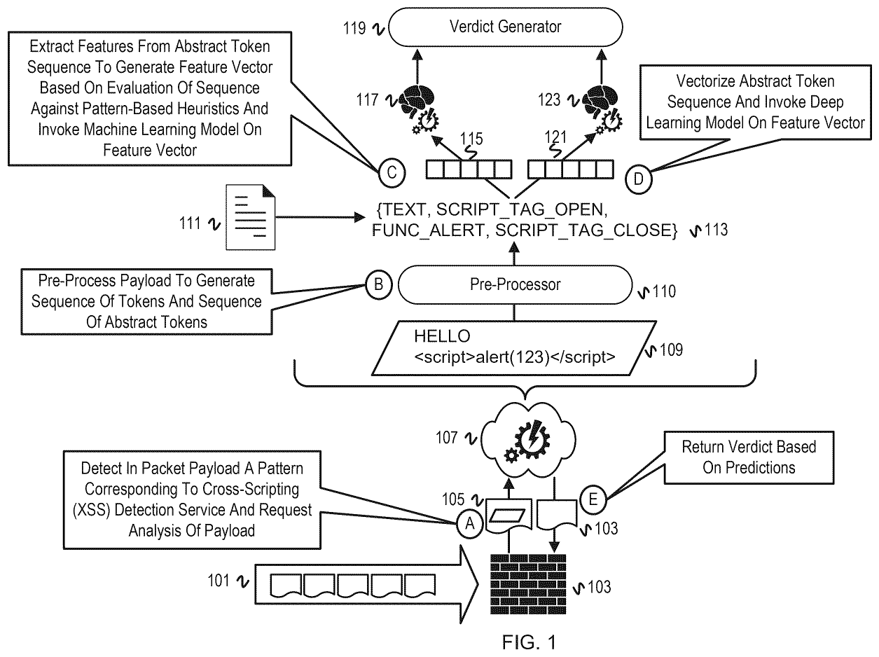

FIG. 1 is a diagram of a multi-perspective XSS detector deployed for inline detection of XSS. FIG. 1 illustrates deployment of a multi-perspective XSS detector 107 for inline detection of XSS in network traffic 101 for a firewall 103. The multi-perspective XSS detector 107 can be exposed to the firewall as a cloud-based service accessible via web application programming interface (API) calls. The multi-perspective XSS detector 107 includes a pre-processor 110, a machine-learning model 117, deep learning model 123, and a verdict generator 119.

FIG. 1 is annotated with a series of letters A-E representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the firewall 103 detects in packet payload a pattern corresponding to XSS. The firewall 103 scans network traffic 101 against one or more patterns, at least one of which indicates the possibility of XSS in a payload. For example, the firewall 103 uses deep packet inspection to search payloads for a pattern(s) (e.g., a script tag) that indicates XSS. Upon detection of a XSS pattern, the firewall 103 requests analysis of a payload by the multi-perspective XSS detector 107. In this illustration, the firewall 103 detects the XSS pattern in a payload and submits a request 105 that includes the payload.

At stage B, the pre-processor 110 of the multi-perspective XSS detector 107 pre-processes the payload to generate a sequence of tokens. The pre-processor 110 invokes or includes a tokenizer to generate a sequence of tokens from the payload of the request 105. FIG. 1 depicts an example payload 109 that includes “HELLO <script>alert(123)</script>”. Accordingly, the pre-processor 110 generates a token sequence {HELLO, script, alert, 123, script}. The pre-processor 110 then generates a sequence of abstract tokens 113. For instance, the pre-processor 110 performs lexical analysis and generates an abstract syntax tree (AST). From the abstract syntax tree, the pre-processor 110 can extract abstract tokens to replace tokens in the token sequence and form an abstract token sequence. As another example, the pre-processor 110 can map the tokens in the AST to defined abstract tokens. For example, the token sequence {HELLO, script, alert, 123, script} would be converted into the abstract token sequence 113 {text, script_tag_open, func_alert, script_tag_close}. The abstraction of tokens preserves the tokens of functional significance, such as opening and closing tags and functions, while preserving the existence but not detail of non-functional tokens, such as text.

At stage C, the multi-perspective XSS detector 107 extracts features from token sequence to generate a feature vector based on evaluation of the sequence against heuristics-based rules 111. The multi-perspective XSS detector 107 performs feature extraction from the abstract token sequence 113. The multi-perspective XSS detector 107 traverses the rules indicated in the heuristics-based rules 111 to determine whether characteristics of the abstract token sequence 113 satisfy any of the heuristics-based rules 111. Effectively, each rule of the heuristics-based rules 111 corresponds to a feature. The heuristics-based rules 111 can indicate patterns or regular expressions observed as correlating or indicating XSS. Other characteristics can include a number of lines with a pattern or regular expression. Thus, the feature values can be binary flags or counts depending on the features. After generating a feature vector 115 from feature extraction, the multi-perspective XSS detector 107 invokes the machine learning model 117 on the feature vector 115.

At stage D, the multi-perspective XSS detector 107 vectorizes the abstract token sequence 113 and invokes the deep learning model 123 on a feature vector 121. The multi-perspective XSS detector 107 can use a library defined function/method for vectorizing (e.g., word2vec) the abstract token sequence 113 and generate the feature vector 121. The multi-perspective XSS detector 107 then invokes the deep learning model 123 (e.g., a convolutional neural network or recurrent neural network) on the feature vector 121.

At stage E, the multi-perspective XSS detector 107 returns a verdict based on predictions from the models 117, 123. The multi-perspective XSS detector 107 generates a verdict based on predictions from the models 117, 123. The multi-perspective XSS detector 107 can aggregate the predictions (e.g., select a greater prediction or average the predictions). If the greater prediction or prediction average is sufficient for malicious indication, the multi-perspective XSS detector 107 returns a verdict that XSS was detected.

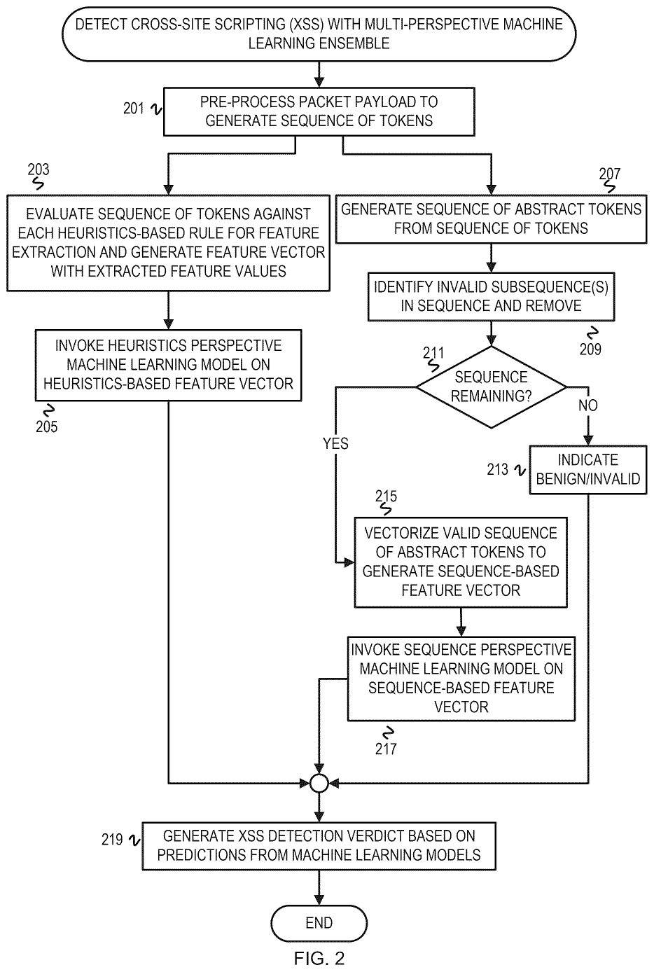

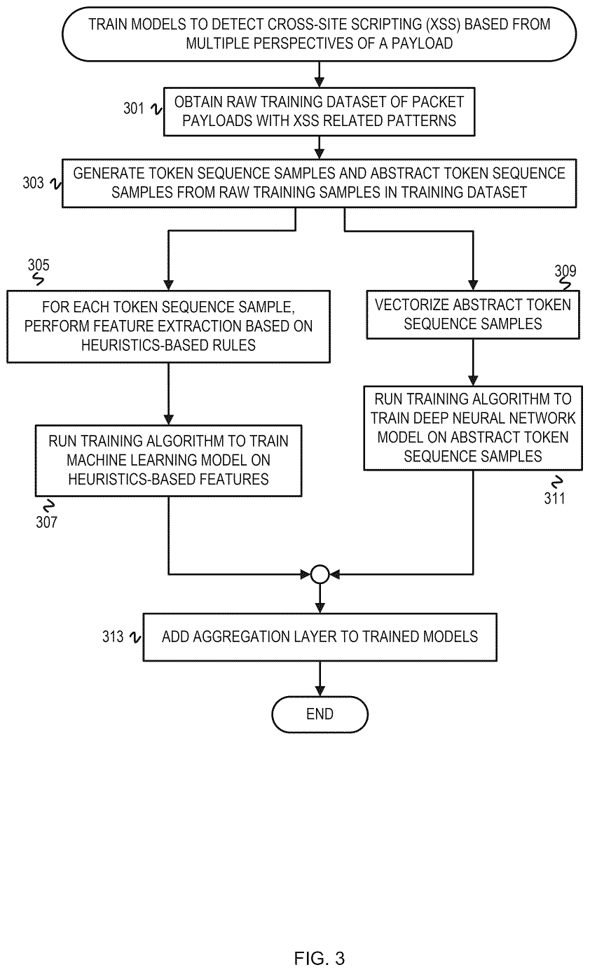

FIGS. 2-3 are flowcharts corresponding to using and training the multi-perspective XSS detector. The example operations are described with reference to a XSS detector as a shorter version of multi-perspective XSS detector for consistency with the FIG. 1 and/or ease of understanding. The example operations of FIG. 3 are described with reference to a trainer. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for detecting XSS with a multi-perspective machine learning ensemble. As noted, the multi-perspective machine learning ensemble will be referred to as the XSS detector for brevity. While any payload can be provided to the XSS detector for analysis, the initial filtering by pattern matching as depicted in FIG. 1 is a possible embodiment to conserve resources and/or reduce queries to the XSS detector. Since there are two pre-processing paths for the two different models, parallelism can be implemented until synchronization for verdict generation.

At block 201, the XSS detector pre-processes a packet payload to generate a sequence of tokens. The XSS detector decodes the packet to generate text. For example, the XSS detector uses any one of a Uniform Resource Locator (URL) decoder, Base64 decode, and a hexadecimal decoder or hexadecimal to ASCII decoder. The XSS detector may also normalize the decoded payload. After decoding and normalizing, the XSS detector tokenizes the decoded payload to generate the sequence of tokens.

At block 203, the XSS detector evaluates the sequence of tokens against each heuristics-based rule for feature extraction. FIG. 1 depicts feature extraction on the abstract token sequence. This flowchart provides an alternative which performs the heuristics-based feature extraction on the token sequence instead of the abstract token sequence. The heuristics-based rules can be authored with respect to either the tokens or abstract tokens. The XSS detector evaluates each of the heuristics-based rules to set a value for the feature corresponding to the rule and eventually generates a feature vector with extracted feature values.

At block 205, the XSS detector invokes a heuristics perspective machine learning model on the heuristics-based feature vector. The invoked model (e.g., XGBoost (Extreme Gradient Boosting) model, Gradient Boosting model, random forest model, etc.) has been trained on heuristics-based features to detect XSS. Operational flow proceeds to block 219.

At block 207, the XSS detector generates a sequence of abstract tokens from the sequence of tokens. Embodiments can use a pre-defined structure that maps tokens to abstract tokens. Embodiments can use the tokens in the AST generated from lexical analysis. Embodiments can use a pre-defined structure that maps tokens generated in a AST to abstract tokens used for training the model to detect XSS. The abstract tokens typically preserve aspects of scripting, such as functions, function names, and tags and/or structural elements of a markup language that would convey a script. The mapping or resolving of a token to an abstract token can be dynamic or static. For instance, text tokens can statically map to a token that specifies the type “TEXT” and the token “<script>” statically map to a token “SCRIPT_OPEN”. For dynamic mapping, the XSS detector can determine a base or template for the abstract token and modify it to be the abstract token. For example, the XSS detector can map the token “alert()” to an abstract token FUNC_ALERT by determining that the token corresponds to a function and concatenating with the function name.

At block 209, the XSS detector identifies invalid subsequence(s) in the abstract token sequence and removes it. The XSS detector can manage resource consumption from model invocation by filtering out invalid subsequences of tokens that would correspond to code that could not execute. In addition, the invalid subsequences may be noise that decreases accuracy of model prediction. A general set of rules can be applied to detect invalid subsequences. For instance, a subsequence with an opening or closing script tag that lacks its counterpart would be identified as an invalid subsequence.

At block 211, the XSS detector determines whether an abstract token sequence remains. In some cases, removal of invalid subsequences eliminates the entire sequence. If no sequence remains, then operational flow proceeds to block 213. If a sequence of abstract tokens remains, then operational flow proceeds to block 215.

At block 213, the XSS detector indicates that the payload is benign/invalid. Indication of either benign or invalid can depend on implementation of how the predictions are used to generate the verdict. For instance, indicating invalid instead of a prediction from the deep learning model may cause the XSS detector to generate a verdict based only on the heuristics perspective machine learning model. Indicating benign instead of a prediction may cause the XSS detector to reduce the prediction from the heuristics perspective machine learning model by a pre-defined factor. Operational flow proceeds to block 219.

At block 215, the XSS detector vectorizes the valid sequence of abstract tokens to generate a sequence-based feature vector. The XSS detector can call a vectorize function with the valid sequence of abstract tokens as an argument. Vectorizing can be done according to word2vec or one hot encoding, as examples.

At block 217, the XSS detector invokes a sequence perspective machine learning model on sequence-based feature vector. The sequence perspective machine learning model is a deep learning model (e.g., a LSTM (Long Short Term Memory), a RNN (Recurrent Neural Network) model, a CNN (Convolutional Neural Network) model, etc.). The deep learning model has been trained to detect XSS based on patterns in sequences of abstract tokens.

At block 219, the XSS detector generates a XSS detection verdict based on predictions from the machine learning models. For instance, the XSS detector can be configured to select the malicious prediction if the predictions diverge. If both predictions are for a same class (i.e., benign or malicious), then the XSS detector can compute an average or select a maximum prediction. The XSS detector may apply thresholds to both predictions, select the prediction(s) that satisfies its corresponding thresholds, and then aggregate to determine a final verdict.

FIG. 3 is a flowchart of example operations for training models to detect XSS based on multiple perspectives of a payload. While the example operations do not delve into common details of training (e.g., split training, epochs, batches, etc.), the operations indicate the separate training paths for machine learning models to obtain a multiple perspective XSS detector. Some of the pre-processing will be similar to that described in FIG. 2 and will not be repeated in detail.

At block 301, a trainer obtains a raw training dataset of packet payloads that include XSS related patterns. The training dataset includes benign payloads and malicious payloads used for XSS.

As in FIG. 2, the trainer generates tokens and performs feature extraction. At block 303, the trainer generates token sequence samples and abstract token sequence samples from raw training samples in training dataset. At block 305, the trainer performs feature extraction on each of the token sequence samples based on heuristics-based rules.

At block 307, the trainer runs a training function to train a machine learning model on heuristics-based features of the token sequence samples. A machine learning model library will define a training function. The machine learning model learns the combinations of heuristics-based features that correlate to XSS.

At block 309, the trainer vectorizes the abstract token sequence samples. Implementations can vectorize in a batch(es) or individually before proceeding to training.

At block 311, the trainer runs a training function to train a deep neural network model on abstract token sequence samples. The deep learning model learns to detect XSS from the other perspective of abstract token sequences in payloads.

At block 313, the trainer adds an aggregation layer to the trained models. To form the multi-perspective machine learning ensemble, an aggregation layer is added. The aggregation layer encapsulates the functionality for generating a verdict based on the predictions from the models. Different implementations of XSS detectors can be created by adding different aggregation layers.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the parallelism suggested in the flowcharts is not necessary. The predictions can be generated sequentially, especially since the execution flows would converge at verdict generation. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

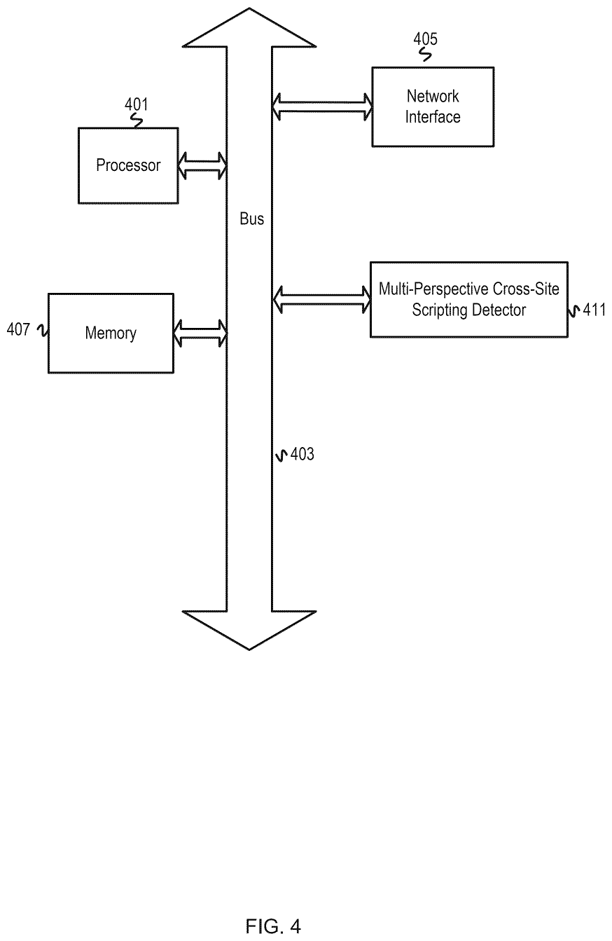

FIG. 4 depicts an example computer system with a multi-perspective XSS detector powered by a machine-learning ensemble. The computer system includes a processor 401 (possibly including multiple processors, multiple cores, multiple nodes, and/or implementing multi-threading, etc.). The computer system includes memory 407. The memory 407 may be system memory or any one or more of the above already described possible realizations of machine-readable media. The computer system also includes a bus 403 and a network interface 405. The system also includes multi-perspective XSS detector 411. The multi-perspective XSS detector 411 includes machine learning models trained from different perspectives of a payload to detect XSS. A first of the machine learning models is trained to detect XSS based on features corresponding to heuristics. A second of the machine learning models is trained to detect XSS based on a sequences of abstract tokens determined from the sequences of tokens extracted from payload, after any decoding and normalizing. Thus, the XSS detector 411 learns to detect XSS from the perspective of patterns in an abstract token sequence and from the perspective of heuristics-based features. When deployed, a layer is added to generate a verdict based on the predictions from the models. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
generating a sequence of abstract tokens based on a tokenized payload;
invoking a first machine learning model to generate a first prediction of whether the payload corresponds to cross-site scripting (XSS) based on the sequence of abstract tokens;
evaluating the sequence of abstract tokens against a set of XSS related heuristics-based rules for feature extraction and generating a first feature vector accordingly;
invoking a second machine learning model to generate a second prediction of whether the payload corresponds to XSS based on the first feature vector; and
generating a verdict for the payload based, at least in part, on the first and second predictions.

2. The method of claim 1 further comprising identifying and filtering out from the sequence of abstract tokens each invalid abstract token subsequence.

3. The method of claim 2, wherein identifying each invalid abstract token subsequence comprises analyzing syntax of subsequences of the sequence of abstract tokens.

4. The method of claim 1, wherein generating the sequence of abstract tokens comprises mapping each of a sequence of tokens to a corresponding one of a plurality of abstract tokens, wherein the tokenized payload comprises the sequence of tokens.

5. The method of claim 4, wherein the plurality of abstract tokens comprises token type, tag type token, function identifying token, and script-related tag type.

6. The method of claim 1, wherein generating the verdict comprises aggregating the first and the second predictions.

7. The method of claim 1 further comprising decoding the payload, normalizing the decoded payload, and tokenizing the payload before generating the sequence of abstract tokens.

8. The method of claim 1 further comprising vectorizing the sequence of abstract tokens to generate a second feature vector, wherein invoking the first machine learning model comprises invoking the first machine learning on the second feature vector.

9. A non-transitory, machine-readable medium having program code stored thereon, the program code comprising instructions to:
generate a sequence of abstract tokens based on a tokenized payload;
invoke a first machine learning model to generate a first prediction of whether the payload corresponds to cross-site scripting (XSS) based on a first feature vector generated from the sequence of abstract tokens;
evaluate the sequence of abstract tokens against a set of XSS related heuristics-based rules for feature extraction and generate a second feature vector based on the evaluation;
invoke a second machine learning model to generate a second prediction of whether the payload corresponds to XSS based on the second feature vector; and
generate a verdict for the payload based, at least in part, on the first and second predictions.

10. The non-transitory, machine-readable medium of claim 9, wherein the program code further comprises instructions to identify and filter out from the sequence of abstract tokens each invalid abstract token subsequence.

11. The non-transitory, machine-readable medium of claim 10, wherein the instructions to identify each invalid abstract token subsequence comprise instructions to analyze syntax of subsequences of the sequence of abstract tokens.

12. The non-transitory, machine-readable medium of claim 9, wherein the instructions to generate the sequence of abstract tokens comprise instructions to map each of a sequence of tokens to a corresponding one of a plurality of abstract tokens, wherein the tokenized payload comprises the sequence of tokens.

13. The non-transitory, machine-readable medium of claim 9, wherein the instructions to generate the verdict comprise instructions to aggregate the first and the second predictions.

14. The non-transitory, machine-readable medium of claim 9, wherein the program code further comprises instructions to decode the payload, normalize the decoded payload, and tokenize the payload before generating the sequence of abstract tokens.

15. The non-transitory, machine-readable medium of claim 9, wherein the program code further comprises instructions to vectorize the sequence of abstract tokens to generate a second feature vector, wherein the instructions to invoke the first machine learning model comprise instructions to invoke the first machine learning on the second feature vector.

16. An apparatus comprising:
a processor; and
a machine-readable medium having instructions stored thereon that are executable by the processor to cause the apparatus to,
generate a sequence of abstract tokens based on a tokenized payload and vectorize the sequence of abstract tokens to generate a first feature vector;
invoke a first machine learning model to generate a first prediction of whether the payload corresponds to cross-site scripting (XSS) based on the first feature vector;
evaluate a sequence of tokens against a set of XSS related heuristics-based rules for feature extraction and generate a second feature vector based on the evaluation, wherein the tokenized payload comprises the sequence of tokens;
invoke a second machine learning model to generate a second prediction of whether the payload corresponds to XSS based on the second feature vector; and
generate a verdict for the payload based, at least in part, on the first and second predictions.

17. The apparatus of claim 16, wherein the machine-readable medium further has stored thereon instructions executable by the processor to cause the apparatus to identify and filter out from the sequence of abstract tokens each invalid abstract token subsequence.

18. The apparatus of claim 16, wherein the instructions to generate the sequence of abstract tokens comprise instructions executable by the processor to cause the apparatus to map each of the sequence of tokens to a corresponding one of a plurality of abstract tokens.

19. The apparatus of claim 16, wherein the instructions to generate the verdict comprise instructions executable by the processor to cause the apparatus to aggregate the first and the second predictions.

20. The apparatus of claim 16, wherein the machine-readable medium further has stored thereon instructions executable by the processor to cause the apparatus to decode the payload, normalize the decoded payload, and tokenize the payload before generating the sequence of abstract tokens.
